(19) United States
(12) Patent Application Publication
(10) Pub. No.: US 2002/0081240 A1
(43) Pub. Date: Jun. 27, 2002

(54) GAS SCRUBBER FOR TREATING THE GAS GENERATED DURING THE SEMICONDUCTOR MANUFACTURING PROCESS

(76) Inventor: DONG-SOO KIM, KOREA (KR)

Correspondence Address: KEVIN L DAFFER, CONLEY ROSE & TAYON, PO BOX 398, AUSTIN, TX, 78767-0398, US

(21) Appl. No.: 09/287,602

(22) Filed: Apr. 7, 1999

(51) Int. Cl. F01N 3/00; F23J 11/00; B32B 27/02; B01D 50/00; B01D 53/34; F01N 3/10; B01D 47/00; B01D 53/14

(52) U.S. Cl. 422/171; 422/168; 422/169; 422/170; 422/172; 422/174; 422/182

(57) ABSTRACT

An improved gas scrubber is provided. The gas scrubber includes a combustion chamber and a wetting chamber. Between the combustion chamber and the wetting chamber is a mechanism or means that substantially prevent formation of particulate matter, or powder, forming between the two chambers. The combustion chamber serves to eliminate explosive and flammable elements contained in an incoming gas. Those elements are eliminated by burning the incoming gas. The wetting chamber may be placed below the combustion chamber to eliminate a water soluble element of the gas which is not burned in the combustion chamber by dissolving those elements in water. The mechanism or means placed between the two chambers helps eliminate the powder produced due to the temperature difference between the combustion chamber and the wetting chamber at the interface between the two chambers.

### BACKGROUND OF THE INVENTION

1. Field of the Invention

The present invention relates to a gas scrubber for treating an gas and, more particularly, to a gas scrubber for treating a flammable, explosive and/or toxic gas generated during any manufacturing process.

2. Description of the Related Art

Many manufacturing process use flammable or toxic gases. For example, semiconductor manufacturing involves flammable and toxic gases such as silane (SiH₄). The reaction process involved in semiconductor manufacturing may occur at very high temperatures, and the gas produced during this process requires treatment before being released into the atmosphere. A gas scrubber is generally used to perform such treatment. The gas scrubber must be able to eliminate flammable, explosive and toxic elements contained in the gas produced from, for example, a semiconductor manufacturing process.

A popular, conventional gas scrubber involves a wetting method, whereby water is used to treat the exhaust gas produced during the semiconductor manufacturing process. Although wetting method gas scrubbers are simple in construction and usually have significant capacity, flammable gases or insoluble elements within the gas cannot be treated.

A burning method gas scrubber is another type of conventional gas scrubber used to treat exhaust gases. The burning method gas scrubber directly treats the gas by passing the exhaust gas through a burner or indirectly treats the elements contained in the gas by directing the gas passes through a combustion chamber having a high temperature. This type of the burning method gas scrubber is effective in treating a flammable exhaust gas, however, it is inadequate to treat a toxic gas that is not flammable.

Delatech Corporation has developed a gas scrubber, (model number CDO 857 V-M) which uses both the wetting and burning treatment methods. The combination burning and wetting gas scrubber of Delatech Corp. is formed with a vertically placed burning chamber placed near a vertically placed wetting chamber, with a connection valve extending therebetween. The exhaust gas is first burned in the burning chamber, then treated with water in the wetting chamber. However, this kind of a conventional, combination gas scrubber has many problems.

First, frequent maintenance is required on the combination gas scrubbers because of the formation of a powder in the area where the gas flowing out from the combustion chamber makes contact with water. The powder is a particulate that forms whenever the relatively hot gas contacts a surface cooled by the wetting chamber water. Whenever the combination gas scrubber needs to be repaired, the main manufacturing system that produces the exhaust gas is put on hold thus causing reduction in productivity and throughput of the overall manufacturing system.

Second, when the gas is treated with water in the wetting chamber, a water molecule becomes attached to the toxic gas due to the chemical reaction. When the treated gas is expelled through an exhaust pipe, the water molecule contained in the gas reacts with air and the part of the exhaust pipe where the reaction occurs become rusted. As a result, a rustproof exhaust pipe, which is very expensive, has to be used.

Thirdly, the gas treatment capacity is limited due to the size limitation of the gas scrubber, which is in direct proportion to the space occupied by the gas scrubber. More specifically, the size of an installation space of the gas scrubber is limited, therefore the size of the gas scrubber is restricted to the space available for the installation. In order to generate enough heat for burning the exhaust gas, the conventional gas scrubber had be formed with a small interior burning chamber but long in length to treat a necessary amount of exhaust gas. However, constantly treating a large volume of the exhaust gas is not possible. Moreover, another disadvantage is that the conventional gas scrubber is formed with two separate vertically placed chambers, the combination of which takes up a large installation space.

Korea Pat. No. 97-009311 discloses a related gas scrubber with improvement made by forming the combustion chamber and the wetting chamber in a single unit. Thus, the gas scrubber has a large capacity and can be installed in a smaller space. Inconel valves are configured in a v-shape within the heating chamber and bar heaters are inserted inside the Inconel valves to generate heat so that heat is released from an outer wall of the Inconel valve.

The bottom part of the wetting chamber is v-shaped, with a drain and a water nozzle placed adjacent the bottom portion of the wetting chamber. When a particulate (or sludge) build-up at the bottom of the wet chamber reaches a certain level, water is injected by the water nozzle to push the sludge out through the drain. The drain involves a valve placed within a drain port to regulate the flow of sludge therein.

The gas scrubber disclosed in Korean Pat. No. 97-009311 has many disadvantages. For example, due to the positioning of the Inconel valves in the combustion chamber, spaces between the Inconel valves are narrow. As a result, a powder buildup could either slow down or completely block the flow of the gas. Due to the temperature difference between the combustion chamber and the wetting chamber, a powder or particulate buildup is created at the interface between the two chambers. It is believed the powder results from the relatively hot gas of the combustion chamber contacting a cooler gas or a cooler surface of the wetting chamber. Bar heaters are connected to an external power conductor with a clamp made of a stainless material. However, due to the high temperature of the bar heater, the clamp is exposed to oxidation and thermal variation, including the stress of such thermal variation. Another disadvantage is that in order to maintain the water level at a fixed level, a sensor is attached in the wetting chamber. When the sensor malfunctions, however, the water level cannot be properly maintained and the water level will be difficult to monitor. Still another disadvantage is that there is no prevention against backward flowing of the gas from the combustion chamber to the main system. Such backflow may cause damages not only to the exhaust gas inlet, but also to the main manufacturing system upstream to the gas scrubber. The present invention is equipped to overcome foregoing problems of the conventional gas scrubbers.

### SUMMARY OF THE INVENTION

An object of the present invention is to provide a gas scrubber to treat a flammable and noxious elements of the gas produced during any manufacturing process involving a gaseous discharge. An example of such a process includes a semiconductor manufacturing process.

These and other objects are achieved by an improved gas scrubber. The gas scrubber includes a combustion chamber for eliminate an explosive and flammable elements contained in a gas by burning an exhaust gas taken in from a gas intake. The gas scrubber may further include a wetting chamber placed below the combustion chamber to eliminate a water soluble element of the gas which is not burned in the burning chamber by dissolving that element in water. Elimination or minimization of power can also be achieved at the interface between the combustion chamber and the wetting chamber. Powder is produced due to a temperature difference between the combustion chamber and the wetting chamber at the border between two chambers. A mechanism is used to reduce the production of powder and/or sweep the powder away at said interface.

Additional objects are attained by the gas scrubber comprising a combustion chamber which includes a case connected with at least two gas intakes and an air intake. A heating mechanism is installed near the inside of the case for heating the gas at an appropriate temperature as it flows into the case from the gas intake.

Still further objects are attained by the gas scrubber comprising a wetting chamber having a case that includes a central portion formed with a plurality of partitions configured to form a passage for directing the gas flow from the combustion chamber. Contained in the lower part of the wetting chamber is water and, more specifically, a plurality of water-drenched absorbers. The absorbers are installed in the gas passage formed by the partitions. The plurality of water-drenched absorbers serve to dissolve the water soluble harmful elements contained in the gas as the gas flows in up and down directions, passing through the absorbers alternatively. A shower nozzle installed above the absorbers sprays water across the absorbers. An exhaust pipe extends into the wetting chamber to allow treated gas to be removed from the wetting chamber. The treated gas is removed of the harmful elements within the gas.

### DESCRIPTION OF THE DRAWINGS

FIG. 1 is a partially broken away front perspective view of gas scrubber accordance with the present invention.

FIG. 2 is an exploded view of the gas scrubber of FIG. 1.

FIG. 3 is a cross-sectional view of the gas scrubber of FIG. 1

FIG. 4 is a fragmentary cross-sectional view taken in the line A-A of FIG. 3.

FIG. 5 is a cross-sectional view of the gas scrubber of FIG. 1 showing a combustion chamber.

FIG. 6 is a cross-sectional view illustrating the process according to the embodiment of gas scrubber.

FIG. 7 is a cross-sectional view illustrating the process according to the embodiment of gas scrubber.

### DETAILED DESCRIPTION OF THE INVENTION

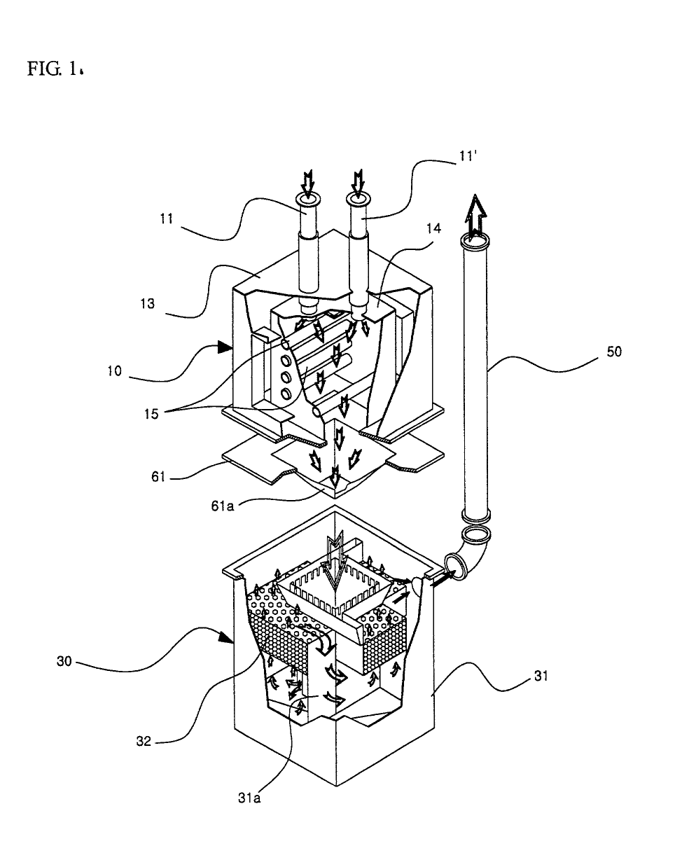

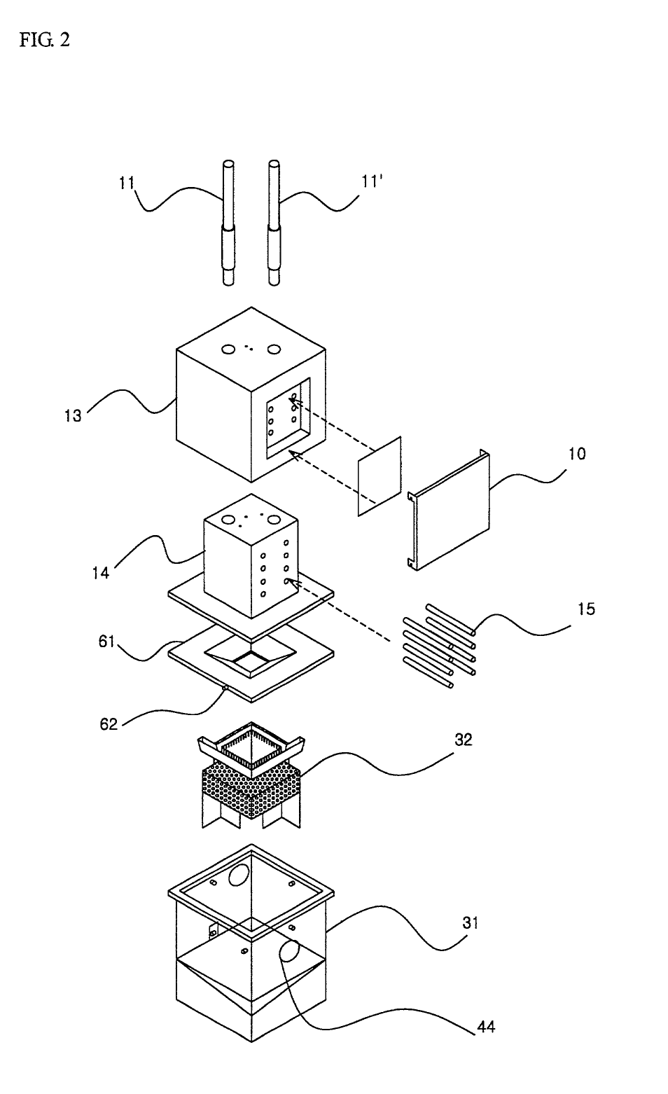

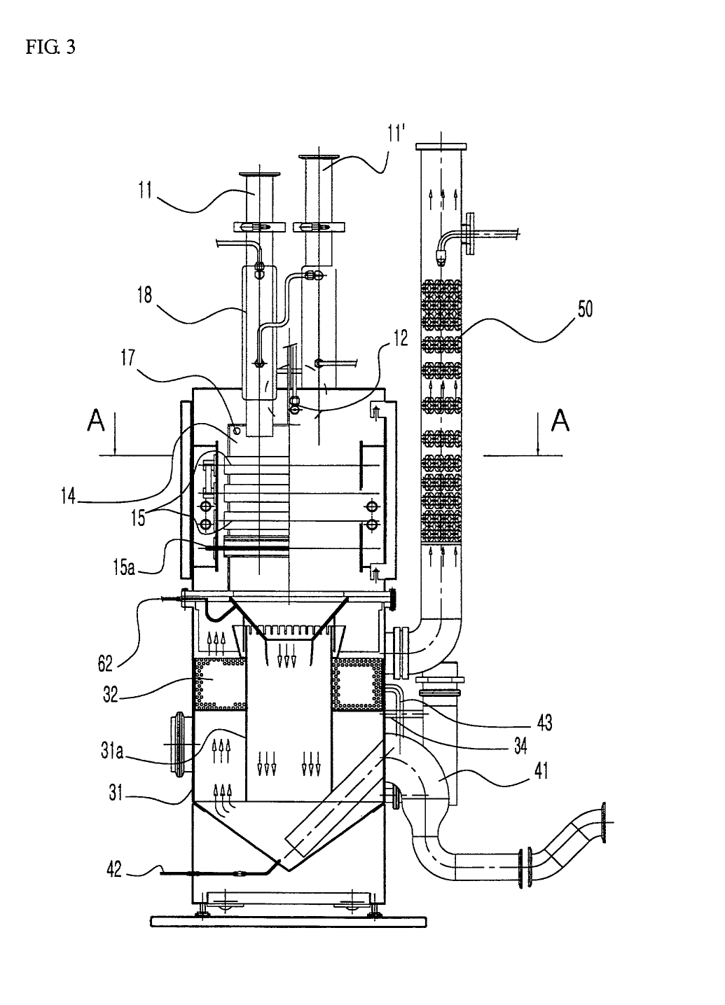

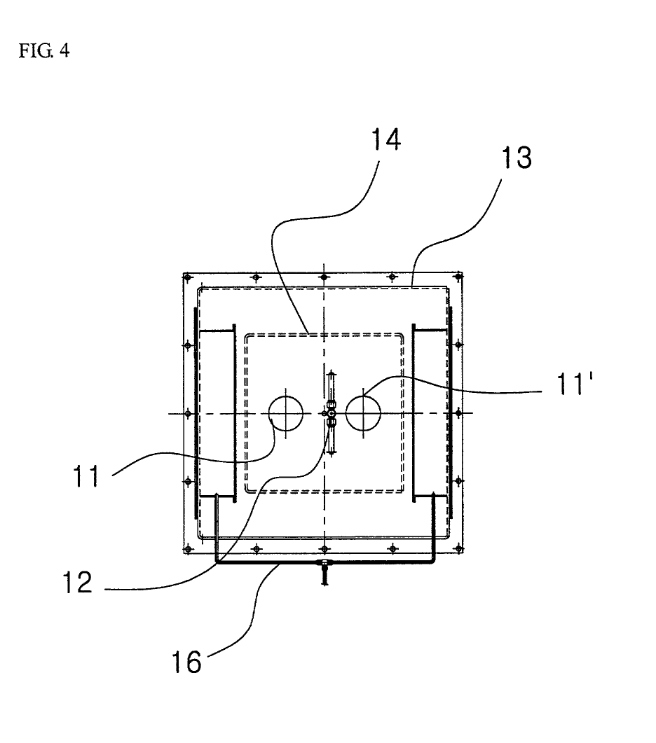

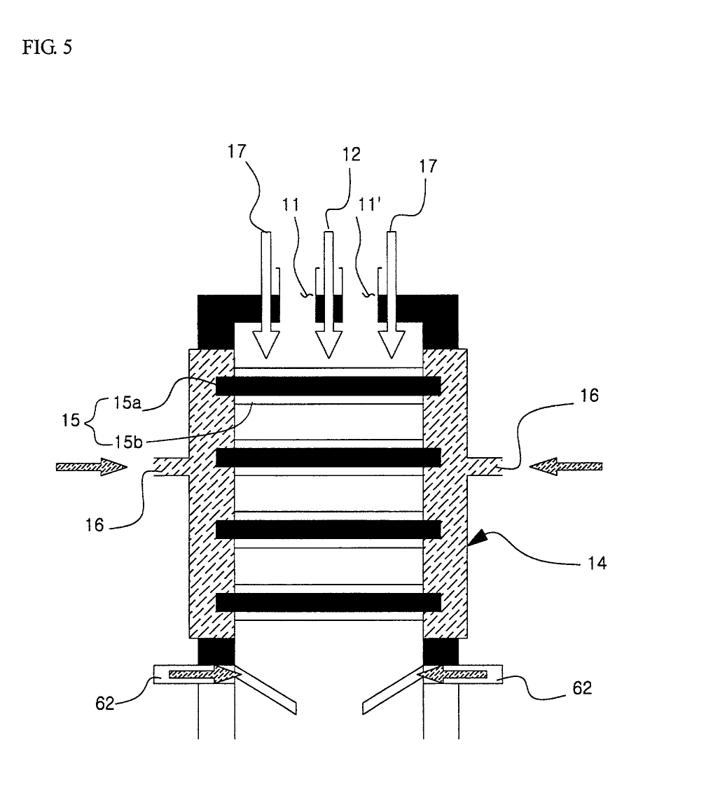

As illustrated in the FIGS. 1-5, a combustion chamber 10 is illustrated for burning explosive and flammable elements contained in an incoming gas. A wetting chamber 30 is used to dissolve water soluble elements of the gas. A powder removal means is used to remove the powder produced due to the temperature difference between the combustion chamber 10 and the wetting chamber 30.

The gas that has been treated in the combustion chamber 10 and the wetting chamber 30 to eliminate a noxious and harmful element of the gas is released to the atmosphere through the exhaust pipe 50 extending from the wetting chamber 30.

The combustion chamber 10 includes a case 13 connected to at least two gas intakes 11, 11′ and one or more air intake 12. The case 13 has a heating means to apply heat to the gas that enters in via attached gas intakes 11, 11′.

The heating means may include a heating chamber 14 and a plurality of heat exchange units valves 15 placed in line from an upper to a lower part of the heating chamber 14, forming two rows. The heat exchange units may comprise Inconel valves that are placed in double lines run from the upper part to the lower part of the heating chamber 14 in order to supply heat evenly to the exhaust gas. The temperature can be adjusted by adding or reducing heat to the (or the number of) Inconel valves. A ceramic heater 15a that generates heat with electricity is placed in the inside of the heat exchange unit 15. An insulator such as quartz 15b, which is a heat retention material, is placed between the heater 15a and heat exchange unit outer surface.

A controller controls the amount of heat by regulating the flow of electricity. The heaters 15a are divided into two sets and two different sets of electricity supply means are connected to the heaters, respectively. And when electricity is discontinued in one set of the heaters, twice the amount of electricity is then supplied to other set of heaters to generate twice the heat to those heaters. The heater 15a is connected to an electric wire (or conductor) with a clamp made of a stainless material, and when the high temperature is transmitted, oxidation or thermal variation may occur upon the clamp which can result in breakage of a wire. In order to prevent the thermal variation or the oxidation occurring in the clamp, a nitrogen nozzle 16 is attached to supply nitrogen across the clamp, to cool the clamp and prevent oxidation thereon.

A cleaning air nozzle 17 is placed at both sides of upper part of the heater chamber 14 to blow off a powder buildup created on a surface of each heat exchange unit 15. The air nozzle 17 operates periodically based on the predetermined time period set up in the scrubber to supply air automatically to remove the powder buildups. Therefore, decrease in an efficiency rate due to the powder buildups can be prevented and the system need not be interrupted for removing the powder.

It is preferred that combustion chamber 10 be maintained at the fixed temperature to achieve an effective combustion process. However, if the temperature of the combustion chamber 10 is not maintained at the fixed temperature, a sudden gas reaction may occur within the chamber and the rapid gas expansion may erupt which results in the gas flowing backward to the gas intakes 11, 11′. The gas flowing backward may cause serious damage to the main manufacturing system. Thus a prevention measure must be established. Namely, a water jacket 18 is used having a cooling water routed through jacket 18 configured adjacent the gas intake wall. The cooling jacket serves to cool the heated gas flowing backward into the main system, and thus explosion or other dangerous results are prevented.

After passing through the combustion chamber 10 and the explosive and flammable elements are removed, the gas flows into the wetting chamber 30 placed below the combustion chamber 10 forming a single unit. The wetting chamber 30 comprises a case having a central part that is formed with a plurality of partitions 31a to configured to form a passage where the gas enters from the combustion chamber 30, and the lower part of the chamber contains water. A plurality of absorbers installed in the gas passage formed by the partitions 31a of the case 31 are then used to dissolve the water soluble harmful elements contained in the gas as the gas flows in an up and down direction along the passage and passes through a plurality of absorbers 32 alternatively. A shower nozzle 33 installed above each absorber sprays water to the corresponding absorber, and an exhaust pipe 50 is used let out the treated gas removed of the harmful elements to the atmosphere.

The bottom of the case 31 is formed in v-shape for collecting byproduct particles. A drain 41, and a water nozzle 42 are installed at the lateral side of the v-shape bottom. A sensor 34 is placed above the drain valve 41 to monitor the water level. An output signal from the sensor 34 initiates the water nozzle 42 to inject water to push the water-entrained particles, or sludge, out to the drain valve 41 when the sludge gathered at the bottom of the case 31 reaches a certain amount and causes rise of the water level. A transparent plate 44 is hinged on one side of the case so that the water level could be checked from outside in case the sensor malfunctions.

A pressure tube 43 is placed in the space between the case 31 and the drain valve 41, to serve as a pressure buffer, so that the pressure of the wetting chamber 30 is maintained at a constant level, and thus the water level is also maintained at a same level regardless of the variation of an exhaust gas pressure. The inside of case 31 and the exhaust pipe 50 is preferably coated with Teflon® to prevent erosion due to the corrosive gas.

A means for removing the powder or particulate matter at the interface of the two chambers includes a guide plate 61 attached with two plate materials 61a having a square funnel-shaped guide. The guide plate guides the exhaust gas from the combustion chamber 10 to the wetting chamber 30, and an injection nozzle 62 installed on all four sides of the guide plate 61 to inject air or nitrogen for removing the powder through the space of the guide plate 61. According to one example, the powder may be removed laterally into the space above the guide plate. Alternatively, the powder may be removed through the opening of the four-sided guide plate downward into the wetting chamber.

The nozzle 62 continuously supplies air or nitrogen to the plate material 61a of the guide plate 61 such that a high temperature gas and a low temperature gas do not come in contact with each other. As a result, the powder buildup at the border between the combustion chamber 10 and the wetting chamber 30 is prevented.

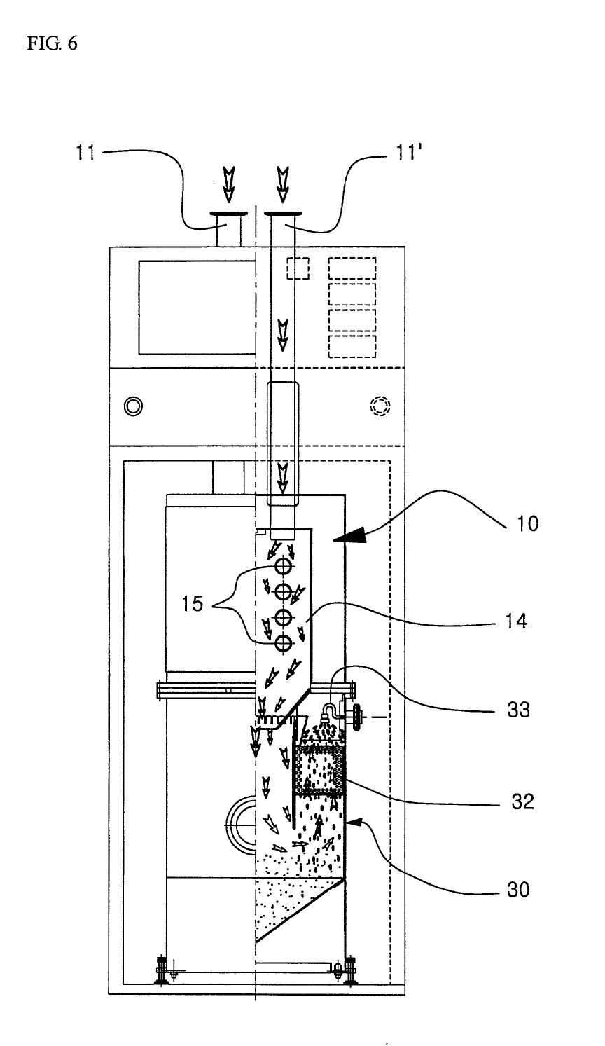

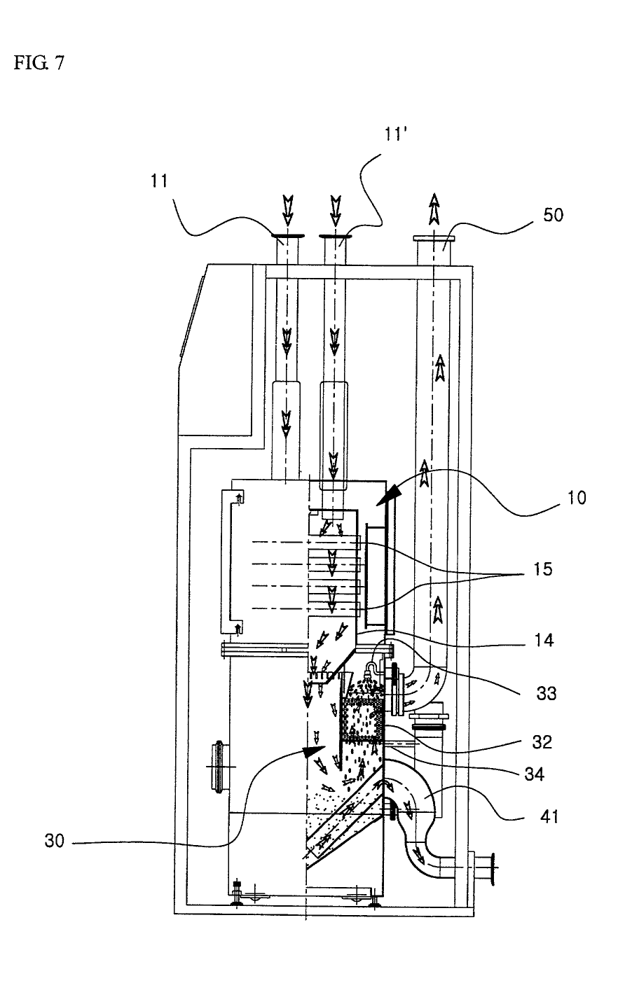

FIGS. 6 and 7 are hereby used to illustrate various methods for treating the gas produced during the semiconductor manufacturing process with the gas scrubber. The gas comprising hydrogen and other noxious elements that were not treated in the CVD furnace is fed into the combustion chamber 10 through the gas intake 11, 11′. A number of the gas intake 11, 11′ used are preferably based on the maximum capacity of the gas scrubber. For example, if the maximum capacity of the gas scrubber is 2000 slm, then four exhaust gas service pipes connected to four devices that exhaust 500 slm of exhaust gas should be formed. The modular addition of exhaust gas pipes and associated combustion chambers is thereby contemplated.

The exhaust gas gains heat by passing though the heat exchange unit, or Inconel valve, 15. Each heat exchange unit includes a ceramic heater 15a which raises the temperature of an outer surface of the heat exchange unit to 800° C., and as a result, the flammable gas, such as hydrogen, and explosive elements are burned in the combustion chamber 30. The air intake 12 attached at the upper part of the heater chamber 14 sprays out air at the fixed time period to remove the powder buildup occurring while the gas is being burned. Removed powder then drops to the bottom of the case.

Therefore, the exhaust gas that enters the wet chamber 40 preferably consists of non-flammable elements. Due to the temperature difference between the high temperature process of the combustion chamber 10 and low temperature process of the wetting chamber 30, a powder could be created above or on plate 61. However, continual application of air and nitrogen to a space of the plate 61 block possible contact between air of the combustion chamber 10 and air of the wetting chamber, and thus creation of a powder is substantially prevented.

The gas entered into the wetting chamber 30 flows into the center of the absorber 32. Thereafter, in the inside of the wetting chamber 30, the gas flows from a lower to upper part and then upper to lower part, passing through a plurality of absorbers 32. During this process, the shower nozzle placed at the top continuously sprays water and, as a result, the water-soluble elements contained in the toxic and noxious gas is removed. At the same time, the gas is cooled due to a cooling effect of water.

Since the process of up and down flow of the gas along the passage through a plurality of absorbers 32 is repeated until the gas has been completed its flow through all absorbers in the wetting chamber 30, the path at which the gas takes becomes longer and the effectiveness of the absorbing process is increased. Forwarding the gas into water contained in the wetting chamber 30 dissolves the gas molecules combined with the water molecule.

Finally the gas treated for elimination of the toxic element and the flammable and explosive elements, is then released to the atmosphere through the exhaust pipe 50. The gas molecules absorbed by water are gathered at the bottom part of the wetting chamber 30 in a form of sludge, and when a certain amount of sludge is gathered, the water level rises. A sensor (not illustrated in the drawings) that monitors the water level sends out a signal to initiates the water nozzle 42 to inject water to push the sludge out to the drain valve 41. Therefore, the sludge removal is done automatically and spending an extra time to remove the sludge is no longer required.

As described above, the gas that enters the wetting chamber 30 is led to flow in up and down directions which results in increase in length of the passage where the gas makes contact with water. As a result, the capacity is much larger than the conventional gas scrubber while taking up a smaller installation space.

The heater chamber 14 is heated with the heat exchange units 15, and since the gas passes through the spaces in between the units 15, enough heat for burning the flammable elements of the exhaust gas is generated. Heat is generated at a much higher thermal efficiency than the conventional hot wall-type burning chamber. Furthermore, and since the ceramic heater 15a inserted in the each heat exchange unit 15 can be replaced or repaired without effecting intake of the gas, operation of the main manufacturing system need not be interrupted to repair the gas scrubber. This would be very advantageous in terms of the preventing downtime and thereby enhancing productivity.

Furthermore, the gas scrubber automatically removes a powder buildup in the heat exchange units 15 of the heater chamber and prevent the powder buildup at the border between the combustion chamber and the wetting chamber so that stoppage of the system to remove the powder is no longer necessary.

Although the preferred embodiments of the present invention have been disclosed for illustrative purposes, those skilled in the art will appreciate that various modifications, additions and substitutions are possible after having the benefit of this disclosure, without departing from the scope and spirit of the invention as disclosed in the accompanying claims.

What is claimed is:

1. A gas scrubber comprising:
a combustion chamber;
a wetting chamber placed below said combustion chamber to form a single unit;
a guide plate arranged between the combustion chamber and the wetting chamber for directing a gas from the combustion chamber into the wetting chamber; and
an injection nozzle having an opening adapted to deliver a conditioned gas above the guide plate for minimizing the production and/or accumulation of a powder at an interface between the combustion chamber and the wetting chamber.

2. The gas scrubber according to claim 1, wherein the combustion chamber is adapted to burn a flammable gas delivered to the combustion chamber.

3. The gas scrubber according to claim 1, wherein the wetting chamber is adapted to receive water which absorbs a portion of the gas directed from the combustion chamber that is not burned.

4. The gas scrubber according to claim 1, wherein the wetting chamber comprises:
an angled bottom surface which collects particulates from the gas that is not burned; and
a water expulsion nozzle having an opening directed to the angled bottom for flushing the particulates into a drain which opens into the wetting chamber.

5. The gas scrubber according to claim 1, wherein the wetting chamber comprises:
a plurality of water drenched absorbers across which the gas is directed; and
an exhaust pipe having an opening extending into the wetting chamber for receiving the directed gas after said gas is passed across at least a portion of the water drenched plurality of absorbers.

6. The gas scrubber according to claim 1, wherein the gas delivered from the combustion chamber is a relatively high temperature gas that cools as it traverses the plurality of water drenched absorbers, and wherein the conditioned gas is delivered above the guide plate such that the gas delivered from the combustion chamber does not directly contact a substantial portion of the cooler gas that traverses the plurality of water drenched adsorbers.

7. A gas scrubber comprising:
a combustion chamber for eliminating explosive and flammable elements contained in a gas delivered into the combustion chamber from a gas intake;
a wetting chamber placed below said combustion chamber to receive the gas and dissolve a water soluble element of the gas which is not burned in said burning chamber; and
a means for minimizing a powder produced due to a temperature difference between said combustion chamber and said wetting chamber at an interface between said burning chamber and said wetting chamber.

8. The gas scrubber according to claim 7, wherein said combustion chamber comprises:
a case connected to receive the gas intake and an air intake; and
a heating means placed in the inside of said case for applying heat to the gas flowing into said case from the gas intake.

9. The gas scrubber according to claim 7, wherein said heating means includes:
a heating chamber;
multiple heat exchange units arranged within rows inside said heating chamber, wherein each of said heat exchange units comprise an electrical heating element configured inside a ceramic; and
a pair of cleaning air nozzles installed on both upper sides of said heater chamber for periodically delivering air across the ceramic surface of the heat exchange units to minimize accumulation of powder upon an outer surface of the ceramic.

10. The gas scrubber according to claim 9, wherein each of the multiple heat exchange units comprise an insulator, such as quartz, configured between an outer surface of the heat exchange unit and the ceramic in order to prevent the short between the electrical heating element and the outer surface of the heat exchange unit.

11. The gas scrubber according to claim 7, wherein each of the multiple heat exchange unit comprises an Inconal valve.

12. The gas scrubber according to claim 9, wherein the combustion chamber comprises a nitrogen delivery nozzle having an opening directed into the heating chamber for supplying nitrogen across a clamp which connects the multiple heat exchange units to an electrical power conductor.

13. The gas scrubber according to claim 9, wherein the multiple heat exchange units are arranged in two substantially parallel rows and are connected the electrical power, whereby if power to one row of the multiple heat exchange units is terminated, power to the other of row of the multiple heat exchange units will receive a double amount of power.

14. The gas scrubber according to claim 7, wherein a water jacket is installed on said gas intake in order to cool the gas within the combustion chamber and prevent high temperature and high pressure said gas from flowing backward into the gas intake.

15. The gas scrubber according to claim 7, wherein said wetting chamber includes:
a case having a region centralized within the case, around which a plurality of partitions are formed to direct passage of the gas through the case from said combustion chamber;
a plurality of absorbers installed in the gas passage formed by the partitions of said case, said plurality of absorbers at least partially drenched in water for dissolving water soluble elements contained in the gas as the gas flows through the absorbers and along the passage;
a shower nozzle having a water delivery opening directed above each of said plurality of absorber for drenching said plurality of absorbers; and
an exhaust pipe having an opening extending into the case for expelling a portion of said gas to an ambient outside of said case.

16. The gas scrubber according to claim 15, wherein a bottom portion of said case is configured in a v-shape to collect particles entrained within water residing within said bottom portion, said bottom portion further comprising a drain valve and a water nozzle coupled on a lateral side of the v-shaped bottom.

17. The gas scrubber according to claim 16, further comprising a sensor placed above the drain valve to monitor the water level, and send a signal to initiate said water nozzle to inject water to push the water-entrained particles, or sludge, out to the drain valve when the sludge gathered at the v-shape bottom reaches a certain amount and causes rise of the water level.

18. The gas scrubber according to claim 16, wherein a pressure tube is placed in the space between said case and a valve arranged within the drain to monitor the pressure such that the pressure within said wetting chamber is maintained at a constant level, and thus the water level is also maintained at substantially the same level regardless of the variation of an exhaust gas pressure.

19. The gas scrubber according to claim 15, wherein a transparent plate is hinged on one side of said case so that the water level can be checked from outside.

20. The gas scrubber according to claim 15, wherein an inner surface of said case and an inner surface of the exhaust pipe are coated with Teflon.

21. The gas scrubber according to claim 15, wherein said means for minimizing a powder includes:
a guide plate attached with two plate materials having a square funnel-shaped guide configured to guide the gas from said combustion chamber to said wetting chamber; and
an injection nozzle installed on all four sides of said guide plate to inject air or nitrogen above the guide plate for removing the powder from the guide plate through an opening formed by the funnel-shaped guide.
